(19) United States
(12) Patent Application Publication
(10) Pub. No.: US 2004/0200974 A1
(43) Pub. Date: Oct. 14, 2004

(54) Systems for detection, imaging and absorption of high energy radiation

(76) Inventors: Haim Hermon, Jerusalem (IL); Asaf Zuck, Jerusalem (IL); Misha Lukach, Jerusalem (IL); Rima Kozlov, Kiryat Arba (IL); Michael Schieber, Jerusalem (IL)

Correspondence Address: SQUIRE, SANDERS & DEMPSEY L.L.P, 600 HANSEN WAY, PALO ALTO, CA, 94304-1043, US

(21) Appl. No.: 10/481,193

(22) PCT Filed:
(86) PCT No.: PCT/IL02/00470

(30) Foreign Application Priority Data
Jun. 19, 2001 (IL) 143851

(51) Int. Cl. G01J 1/00

(52) U.S. Cl. 250/370.12

(57) ABSTRACT

An element adapted for at least one use selected from high energy radiation detection, imaging and barrier use, which includes a planar substrate on a surface of which there is a layer polycrystalline mercuric iodide, which has been deposited from the vapor phase, having a thickness within the range of from more than 0.5 mm and up to about 10 mm. A process for preparing an element having such thicknesses. A planar substrate, having deposited on a surface thereof, a layer of mercuric iodide in at least two discrete adjacent sub-layers having a total thickness within the range of from greater than 0.5 mm to about 10 mm. A system adapted for at least one purpose selected from radiation detection, radiation imaging and high energy absorption, which includes an element having thicknesses as described above.

### FIELD OF THE INVENTION

The present invention relates to a planar substrate containing an ultra-thick layer of mercuric iodide, for use in systems for detecting, imaging and acting as a barrier to high energy radiation.

### BACKGROUND OF THE INVENTION

It is known that detectors and imagers for ionizing radiation comprising a substrate coated with mercuric iodide, having a maximum thickness of the mercuric iodide layer of about 500 microns, provide a high output signal and wide band gap, see e.g., U.S. Pat. No. 5,892,227, to Schieber M., et al, the entire contents of which are incorporated herein by reference.

Modern diagnostic techniques use radiation of increasingly higher energy, such as X-rays, γ-rays and isotopic particle radiation. Thus, there exists a need for detectors and imagers which are able to function effectively in such a high energy environment, and which can act as high energy barriers, or in other words, can effectively stop the transmission of high energy radiation.

It is an object of the present invention to contribute to the fulfillment of this need, by providing ultra-thick polycrystalline mercuric iodide detectors, imagers and barriers, particularly those which are able to collect more efficiently the charges produced by such radiation.

In a paper entitled “Thick Films of X-ray Polycrystalline Mercuric iodide Detectors”, published in connection with the AACG conference at Vail in August 2000, it was mentioned that PVD films can be deposited up to a thickness of 1800 microns, and a 1.15 mm film is mentioned. However, a film of only 300 microns thickness is described therein as a “thick” film. This paper does not teach specifically how to prepare such films having an unconventional thickness of more than 500 microns, nor does it suggest at all that films of greater thickness than 1800 microns would have any utility or that they could be prepared by PVD techniques.

### SUMMARY OF THE INVENTION

The present invention provides in one aspect, an element adapted for at least one use selected from high energy radiation detection, imaging and barrier use, which comprises a planar substrate on a surface of which there is a layer of polycrystalline mercuric iodide, which has been deposited from the vapor phase, having a thickness within the range of from more than 0.5 mm and up to about 10 mm.

In another aspect, the invention provides a process for preparing an element, adapted for at least one use selected from high energy radiation detection, imaging and barrier use, which comprises depositing from the vapor phase a polycrystalline mercuric iodide layer on a surface of a planar substrate, until said layer has a desired thickness selected from the range of from more than 0.5 mm and up to about 10 mm. Preferably, in this process, the planar substrate is a polymer-coated substrate, and/or the layer comprises at least two sequentially deposited adjacent sub-layers.

In yet another aspect, the invention provides a planar substrate, having deposited on a surface thereof, a layer of mercuric iodide in at least two discrete adjacent sub-layers having a total thickness within the range of from >0.5 mm to about 10 mm.

In still another aspect, the invention provides a planar substrate, having deposited on a surface thereof, a layer of mercuric iodide having a thickness within the range of from >0.5 mm to about 10 mm, e.g. >1.2 mm, preferably >1.8 mm, more preferably >2 mm, e.g. >2 mm and up to about 4 mm. Within the stated range, a presently preferred thickness range is from about 0.9 mm to about 1.5 mm.

The invention moreover provides a system adapted for at least one purpose selected from radiation detection, radiation imaging and high energy absorption, which includes at least one radiation detecting, imaging and/or energy absorption element according to the invention, or prepared by a process according to the invention, or at least one planar substrate according to the invention. It is to be understood that the system of the present invention can utilize any electrode structure known in the art.

### BRIEF DESCRIPTION OF THE DRAWINGS

FIG. 1 illustrates an embodiment of a vertical physical vapor deposition (PVD) system for Hgl₂ deposition, which may be used to obtain ultra-thick Hgl₂ layers in accordance with the present invention.

FIG. 2 illustrates a particular embodiment of a horizontal physical vapor deposition (PVD) system for Hgl₂ deposition, which may be used to obtain ultra-thick Hgl₂ layers in accordance with the present invention.

FIG. 3 shows a graph of dark current, versus bias, of an ultra-thick Hgl₂ layer in accordance with an embodiment of the present invention.

FIG. 4 shows a graph of sensitivity, versus electric field, of an ultra-thick Hgl₂ layer in accordance with an embodiment of the present invention.

FIG. 5 shows sensitivity and dark currents as a function of thickness, of ultra-thick Hgl₂ layers, in accordance with embodiments within the scope of the present invention.

### DETAILED DESCRIPTION OF THE INVENTION

The element of the invention may be further characterized by at least one of the following features (A) to (D):

(A) the planar substrate is a polymer-coated substrate;

(B) the layer comprises at least two adjacent sub-layers;

(C) the layer comprises a columnar morphology;

(D) the layer comprises mercuric iodide crystallites of which 90% have a grain size within the range of about 0.01 to about 0.35 mm, subject to a maximum of about one-third of the thickness of the layer.

In a particular embodiment, the mentioned polymer is selected from the group consisting of aliphatic and aromatic ethylenic homopolymers and copolymers, and mixtures thereof.

In particular embodiments of the planar substrate according to the invention, the mercuric iodide layer may comprise a columnar morphology, and/or it may comprise crystallites of which 90% have a grain size within the range of about 0.01 to about 0.35 mm, subject to a maximum of about one-third of the thickness of the layer.

The invention will be illustrated by the following Examples.

### EXAMPLE 1

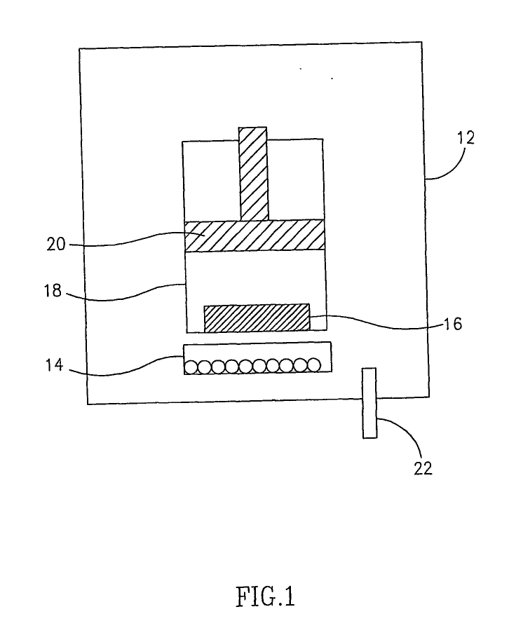

FIG. 1 shows a simplified vertical type furnace which may be used in a particular embodiment, for preparing the polycrystalline mercuric iodide coated substrates intended to be used for the high energy purposes set forth herein. Vacuum chamber 12, which is evacuated via vacuum pipe 22, contains source heater 14 placed below source material 16 enclosed within Pyrex® flask 18. The substrate to be coated is held by substrate holder 20.

Using this furnace, 150 g pure Hgl₂ is charged at 16 into flask 18. The substrate at 20, on which the Hgl₂ is to be deposited, is at a distance of 2.5-3.5 cm above the source Hgl₂ at 16. The chamber is then evacuated via 22 to 10⁻¹-10⁻² Torr, following which the bottom of the flask is heated to 150-200° C. The material is sublimed from 16 and deposited on the substrate at 20. It is important to note that the diameter of the substrate holder is close to the diameter of the flask, leaving only a small amount of vapor to be evacuated from the flask. The temperature of the substrate can reach 120-150° C. However, in spite the high temperature, the growth process may be continued until the desired thickness of the Hgl₂ layer is obtained, e.g. 1-3 mm.

### EXAMPLE 2

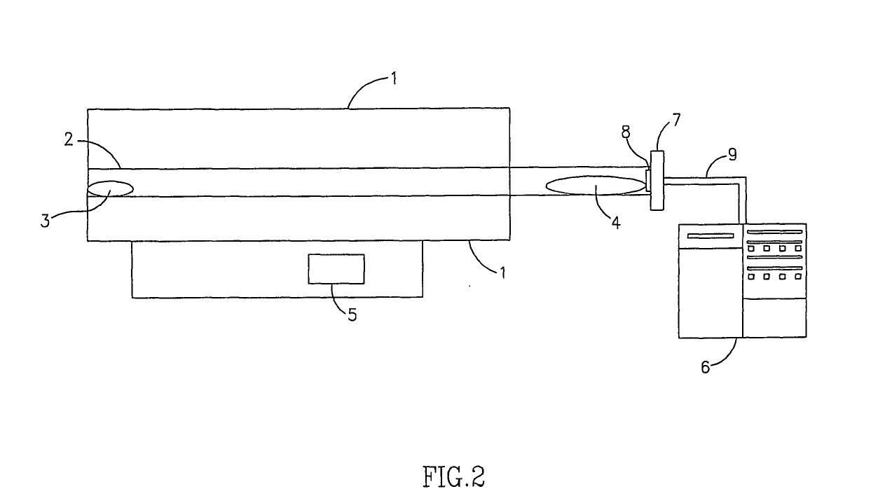

In FIG. 2 there is shown a horizontal type furnace which may be used in a further alternative embodiment, for preparing the polycrystalline mercuric iodide coated substrates intended to be used for the high energy purposes set forth herein. This furnace includes a 100 mm inner Pyrex® elongated tube 2, which is evacuated via conduit 9 by vacuum machine 6. Tube 2 contains source material 3, and is surrounded where indicated by heating element 1, the temperature of which is controlled by device 5. Sublimed Hgl₂ material collects initially at point 4 of tube 2 but thereafter proceeds to coat the substrate 8 (e.g. ITO on glass), which is disposed vertically, being held by metal flange 7.

Using this furnace, 1500 gram of high purity of Hgl₂ is charged into tube 2 at location 3, the tube being 750 mm long×100 mm wide. An ITO glass slide of 1″×3″, for example, is then introduced into the furnace at 8 and is held by flange 7. Tube 2 is then evacuated to a vacuum of 10⁻¹-10⁻² Torr, and the temperature control is set at 170° C. At this temperature, the Hgl₂ is sublimed and condensed initially at point 4 of tube 2 and thereafter on the substrate at 8. The process is continued, usually for at least 24 hours, until the desired thickness of the Hgl₂ layer on the substrate is obtained, e.g. within the range 1-5 mm. After terminating growth by turning off the furnace, the ITO glass slide is then removed and subjected to tests.

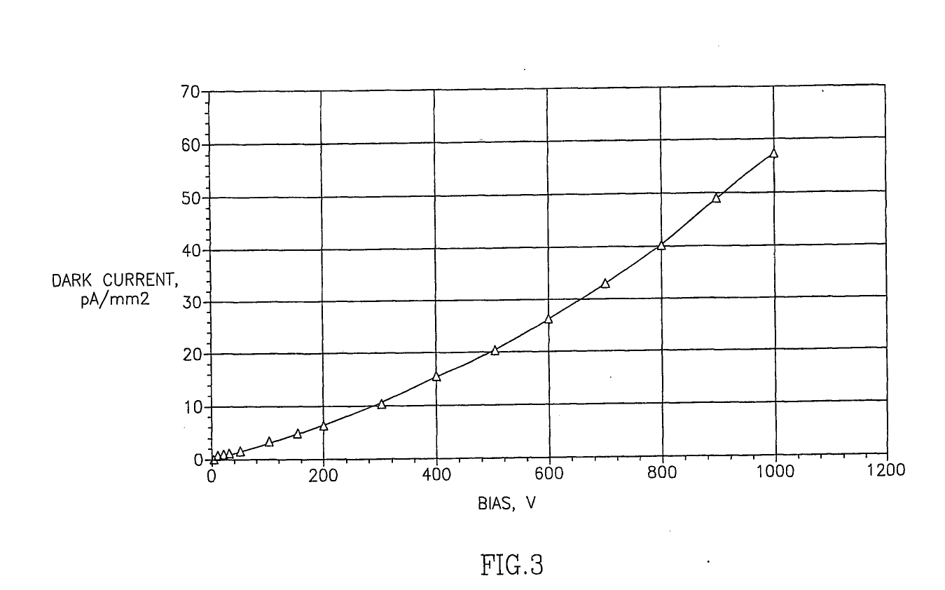

FIG. 3 shows dark current (pA/mm²) versus bias (V) measurements for a 2.7 mm thick polycrystalline mercuric iodide detector, obtained according to the procedure described in Example 2. Up to 50 pA/mm² is considered a low dark current value. In this detector this level is achieved at a bias of 900 volts.

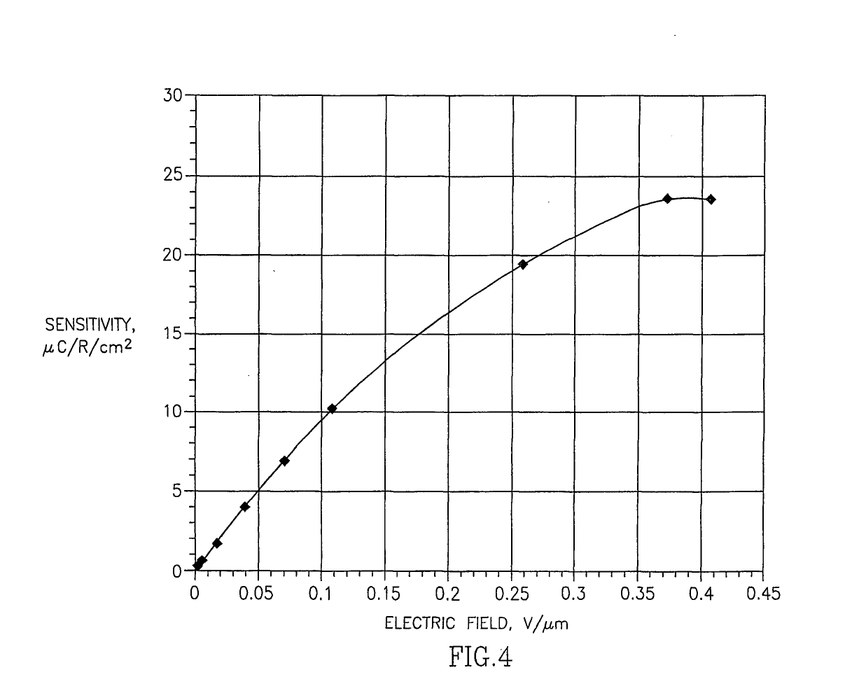

FIG. 4 shows the excellent sensitivity versus electric field results obtained with the same 2.7 mm thick polycrystalline mercuric iodide detector. In this connection, it may be noted that 0.34 V/micron is equivalent to 920 volts.

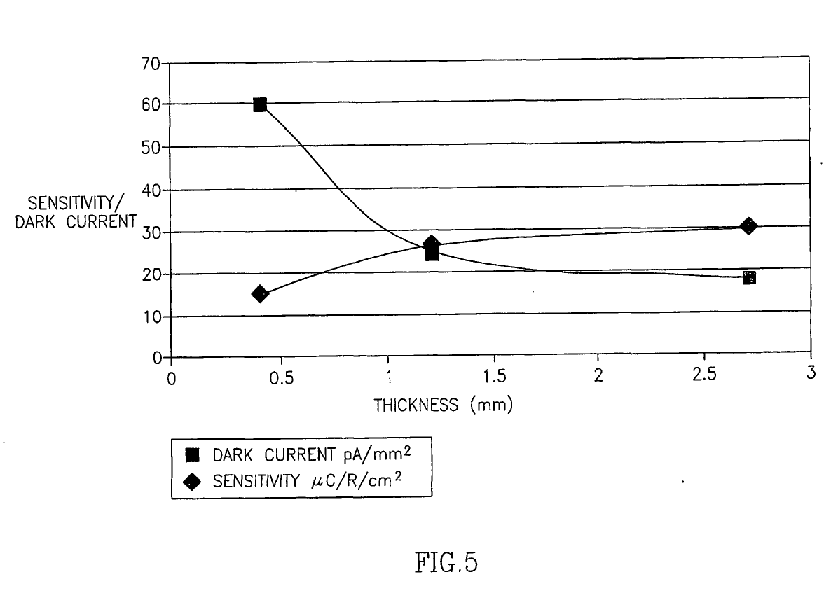

FIG. 5 shows sensitivity and dark current versus thickness measurements over the range of thickness tested. The signal to noise ratio most surprisingly increases as the thickness of the mercuric iodide layer increases. The measurements were made at 0.25 V/p.

### ADVANTAGES OF THE INVENTION

The ultra-thick mercuric iodide films in accordance with the present invention allow the use of much higher energy than in the prior art, e.g. in relation to the new generation of ultra fast CT scanners. Thus these films enable entry into new fields of high energy physics, nuclear radiography and nuclear therapy. Moreover, detectors/imagers comprising the ultra-thick films surprisingly have lower dark currents and much higher sensitivities compared to relatively thinner films.

The thus-formed polycrystalline Hgl₂ detector/digital imaging element for direct ionizing radiation has a high X-ray and γ-ray absorption and low energy electron-hole generation, providing a high output signal per one X-ray quantum and wide band gap, operable at ambient temperatures.

While the present invention has been particularly described with reference to certain embodiments, it will be apparent to those skilled in the art that many modifications and variations may be made. The invention is accordingly not to be construed as limited in any way by the illustrated embodiments, rather its concept is to be understood according to the spirit and scope of the claims which follow.

1. An element, adapted for at least one use selected from high energy radiation detection, imaging and barrier use, which comprises a planar substrate on a surface of which there is a layer of polycrystalline mercuric iodide, which has been deposited from the vapor phase, having a thickness within the range of from more than 0.5 mm and up to about 10 mm, said element being also characterized by at least one of the following features:
(A) said planar substrate is a polymer-coated substrate;
(B) said layer comprises at least two adjacent sub-layers;
(C) said layer comprises a columnar morphology;
(D) said layer comprises mercuric iodide crystallites of which 90% have a grain size within the range of about 0.01 to about 0.35 mm, subject to a maximum of about one-third of the thickness of said layer.

2. An element according to claim 1, wherein said polymer is selected from the group consisting of aliphatic and aromatic ethylenic homopolymers and copolymers, and mixtures thereof.

3. A process for preparing an element, adapted for at least one use selected from high energy radiation detection, imaging and barrier use, which comprises depositing from the vapor phase a polycrystalline mercuric iodide layer on a surface of a planar substrate, until said layer has a desired thickness selected from the range of from more than 0.5 mm and up to about 10 mm.

4. A process according to claim 3, wherein said planar substrate is a polymer-coated substrate, and/or said layer comprises at least two sequentially deposited adjacent sub-layers.

5. A process according to claim 4, wherein said polymer is selected from the group consisting of aliphatic and aromatic ethylenic homopolymers and copolymers, and mixtures thereof.

6. A planar substrate, having deposited on a surface thereof, a layer of mercuric iodide in at least two discrete adjacent sub-layers having a total thickness within the range of from >0.5 mm to about 10 mm.

7. A substrate according to claim 6, in which at least one of the following conditions is fulfilled:
said layer comprises a columnar morphology;
said layer comprises mercuric iodide crystallites of which 90% have a grain size within the range of about 0.01 to about 0.35 mm, subject to a maximum of about one-third of the thickness of said layer.

8. A planar substrate, having deposited on a surface thereof, a layer of mercuric iodide having a thickness within the range of from >0.5 mm to about 10 mm.

9. A substrate according to claim 8, wherein said thickness is >1.2 mm.

10. A substrate according to claim 9, wherein said thickness is >1.8 mm.

11. A substrate according to claim 10, wherein said thickness is >2 mm.

12. A substrate according to claim 11, wherein said thickness is >2 and up to about 4 mm.

13. A substrate according to claim 8, wherein said thickness is within the range of from about 0.9 mm to about 1.5 mm.

14. Apparatus for making an element comprising a planar substrate and adapted for at least one use selected from high energy radiation detection, imaging and barrier use, by physical deposition of a layer on said substrate of polycrystalline mercuric iodide from the vapor phase, said layer having a thickness within the range of from more than 0.5 mm and up to about 10 mm, said apparatus including a horizontal-type furnace.

15. A system adapted for at least one purpose selected from radiation detection, radiation imaging and high energy absorption, which includes at least one radiation detecting, imaging and/or energy absorption element, said element being an element comprised of a planar substrate on a surface of which there is a layer of polycrystalline mercuric iodide, which has been deposited from the vapor phase, having a thickness within the range of from more than 0.5 mm and up to about 10 mm, said element being also characterized by at least one of the following features: (A) said planar substrate is a polymer-coated substrate; (B) said layer comprises at least two adjacent sub-layers; (C) said layer comprises a columnar morphology; and (D) said layer comprises mercuric iodide crystallites of which 90% have a grain size within the range of about 0.01 to about 0.35 mm subject to a maximum of about one-third of the thickness of said layer.

16. A system according to claim 15 wherein said layer of mercuric iodide deposited on a surface of said planar substrate is deposited in at least two discrete adjacent sub-layers having a total thickness within the range of from more than 0.5 mm and up to about 10 mm.

17. A system according to claim 15 wherein said polymer coated substrate includes a polymer selected from the group consisting of aliphatic and aromatic ethylenic homopolymers and copolymers, and mixtures thereof.

18. A system according to claim 17 wherein said layer of mercuric iodide deposited on a surface of said planar substrate is deposited in at least two discrete adjacent sub-layers having a total thickness within the range of from more than 0.5 mm and up to about 10 mm.

19. (Cancelled)

20. (Cancelled)
